(19) United States
(12) Patent Application Publication
(10) Pub. No.: US 2026/0257678 A1
(43) Pub. Date: Sep. 3, 2026

(54) SYSTEMS, METHODS, AND APPARATUSES FOR MINIMUM VEHICLE SPEED CONTROL

(71) Applicant: Cummins Inc., Columbus, IN (US)

(72) Inventor: David Michael Elkins, Columbus, IN (US)

(21) Appl. No.: 18/864,804

(22) PCT Filed: May 3, 2023
(86) PCT No.: PCT/US2023/020811

§ 371 Date: Nov. 11, 2024

Related U.S. Application Data
(60) Provisional application No. 63/365,634, filed on Jun. 1, 2022.

(51) Int. Cl. B60W 30/14; B60W 10/04; B60W 50/00

(52) U.S. Cl. CPC B60W 30/143; B60W 10/04; B60W 50/0097; B60W 2050/0026; B60W 2552/15; B60W 2720/10

(57) ABSTRACT

A control system, apparatus, and method determines a torque limit override condition in response to look ahead route information and an uphill grade. The torque limit override condition operates the prime mover at a modified torque limit to maintain a minimum vehicle speed based on an offset from a cruise control set speed in order to reduce vehicle speed deviations along the uphill grade.

### CROSS-REFERENCE TO RELATED APPLICATION:

The present application claims priority to and the benefit of the filing date of U.S. Provisional Application Ser. No. 63/365,634 filed on Jun. 1, 2022, which is incorporated herein by reference.

### FIELD OF THE INVENTION:

The present disclosure relates to systems, methods, and apparatuses for vehicle speed control, and more particularly to maintaining a minimum vehicle speed along an uphill grade.

### BACKGROUND

Vehicles can be equipped with engine control modules that manage torque limits of the vehicle based on desired performance characteristics. For example, the torque limits on the engine can be set to optimize fuel efficiency, to maximize power output, or to provide a more balanced performance between maximum fuel efficiency and maximum power output. However, the torque limit for the engine associated with the selected performance characteristic may result in vehicle speeds that deviate substantially from a desired speed of the vehicle.

For example, route conditions such as an uphill grade can cause the vehicle speed to deviate from the desired speed due to the default torque limit not being capable of providing sufficient torque output from the engine to maintain the vehicle speed along the uphill grade. As a result, during certain route conditions, drivability, performance, vehicle speed, trip time, and fuel economy of the vehicle can be negatively impacted by the default torque limit. Therefore, there remains a significant need for the apparatuses, methods, and systems disclosed herein.

### DISCLOSURE OF ILLUSTRATIVE EMBODIMENTS

For the purposes of promoting an understanding of the principles of the invention disclosed, reference will now be made to the embodiments illustrated in the drawings and specific language will be used to describe the same. It will nevertheless be understood that no limitation of the scope of the invention is thereby intended. Any alterations and further modifications in the illustrated embodiments, and any further applications of the principles of the invention as illustrated therein as would normally occur to one skilled in the art to which the invention relates, having the benefit of the present disclosure, are contemplated herein.

### SUMMARY

Certain embodiments include unique vehicle systems, methods, and/or apparatuses including minimum vehicle speed controls. In an embodiment, a default or selected torque limit for the prime mover of the vehicle is overridden along at least part of an uphill route segment to maintain a minimum speed for the vehicle along the uphill route segment. In an embodiment, the torque override condition is determined using look ahead route data to identify locations in which a predicted vehicle speed will deviate from a desired speed by more than a threshold amount if operation of the vehicle is maintained at the default torque limit.

In an embodiment, the vehicle operates at a cruise control set speed and follows an associated default torque limit along the uphill route segment until a vehicle speed slows to a specified offset speed from the cruise control set speed. The default torque limit is ramped off, over-ridden, de-prioritized, or otherwise changed to a modified torque limit by momentarily changing the cruise control set speed to the offset (minimum vehicle) speed. The minimum vehicle speed is maintained along the uphill route segment until it is determined the look-ahead speed at a specified distance will increase using the default torque limit.

Further embodiments, forms, objects, features, advantages, aspects, and benefits shall become apparent from the following description and drawings.

### BRIEF DESCRIPTION OF THE DRAWINGS

FIG. 1 is a schematic illustration of a vehicle with cruise control and minimum vehicle speed control apparatuses for speed management of the vehicle.

FIGS. 2A-2C are graphs illustrating terrain profile, speed and prime mover power changes of a vehicle with and without employing minimum speed control.

FIGS. 3A-3C are graphs illustrating terrain profile, speed and prime mover power changes of the vehicle with and without employing minimum speed control, and also including conditions for aborting minimum speed control.

FIG. 4 is a flow diagram of an exemplary minimum speed control procedure.

FIG. 5 is a flow diagram of another embodiment exemplary minimum speed control procedure.

### DESCRIPTION OF ILLUSTRATIVE EMBODIMENTS

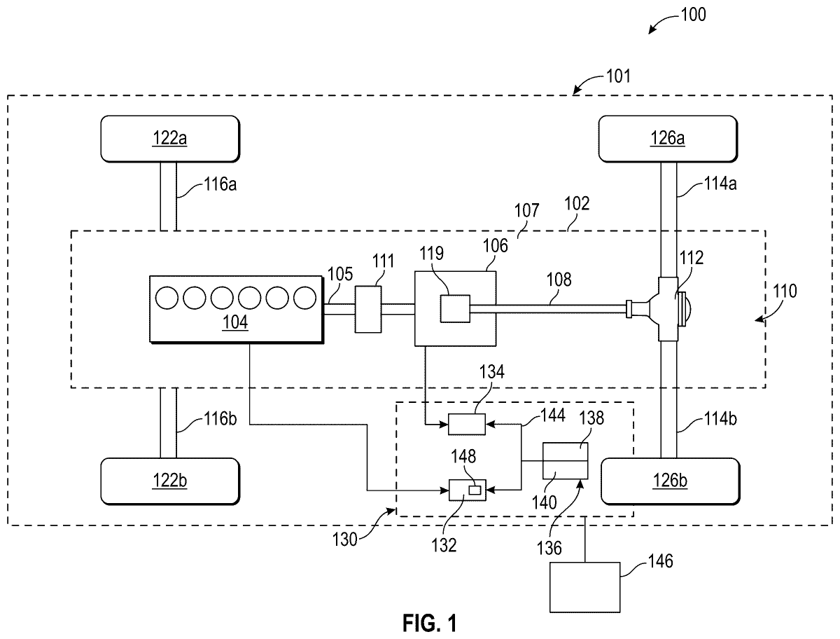

With reference to FIG. 1, there is illustrated a schematic view of an exemplary vehicle system 100 including a powertrain 102 incorporated within a vehicle 101. In the illustrated embodiment, the powertrain 102 includes a prime mover 104, such as an internal combustion engine, electric motor, and/or fuel cell structured to generate power for the vehicle 100. In certain embodiments vehicle 100 may include an electric machine and batteries of appropriate capacity to provide a hybrid electric powertrain in conjunction with an internal combustion engine. The powertrain 102 further includes a transmission 106 connected to the prime mover 104 for adapting the output torque of the prime mover 104 and transmitting the output torque to a driveline 107 including a drive shaft 108.

The transmission 106 may be disengageably connected to crankshaft 105 via a clutch (not shown.) In other embodiments, the transmission 106 may be disengageably connected to crankshaft 105 and the engagement and disengagement may be by operation of a master clutch provided at the front of the transmission, by operation of the transmission to place a gear in a neutral condition, or by other clutch and/or gearing arrangements. Various embodiments contemplate that transmission 106 may be an automatic transmission, an automated manual transmission, or any other suitable transmission with a disconnect device 111 that is operable to selectively engage and disengage prime mover 104 from driveline 107.

In the rear wheel drive configuration illustrated for vehicle system 100, the driveline 107 of powertrain 102 includes a final drive 110 having a rear differential 112 connecting the drive shaft 108 to rear axles 114a, 114b. It is contemplated that the components of powertrain 102 may be positioned in different locations throughout the vehicle 100. In one non-limiting example of a vehicle system 100 having a front wheel drive configuration, transmission 106 may be a transaxle and final drive 110 may reside at the front of the vehicle 100, connecting front axles 116a and 116b to the prime mover 104 via the transaxle. It is also contemplated that in some embodiments the vehicle system 100 is in an all-wheel drive configuration.

In the illustrated embodiment, vehicle system 100 includes two front wheels 122a, 122b mounted to front axles 116a, 116b, respectively. Vehicle system 100 further includes two rear wheels 126a, 126b mounted to rear axles 114a, 114b, respectively. It is contemplated that vehicle system 100 may have more or fewer wheels than illustrated in FIG. 1. Vehicle system 100 may also include various components not shown, such as a fuel system including a fuel tank, a front differential, a braking system, a suspension, an engine intake system and an exhaust system, which may include an exhaust aftertreatment system, just to name a few examples.

Vehicle system 100 includes an electronic control system 130 mounted all or in part on vehicle 101. Electronic control system 130 is directed to regulating and controlling the operation of prime mover 104 among other components of vehicle 101. Electronic control system 130 includes a prime mover control unit (ECU) 132, sometimes referred to as an electronic or engine control module (ECM), or the like. Electronic control system 130 may also include a transmission control unit (TCU) 134, which is directed to the regulation and control of transmission 106 operation. ECU 132 and TCU 134 are each in operative communication with a plurality of vehicle sensors (not shown) in vehicle system 100 for receiving and transmitting operating conditions of vehicle system 101, such as temperature conditions, pressure conditions, speed conditions, fuel conditions, flow conditions to and from the prime mover, terrain conditions, weather conditions, global positioning system (GPS) data, and vehicle mass, for example. It is contemplated that ECU 132 and TCU 134 may be integrated within the prime mover 104 and transmission 106, respectively.

Electronic control system 130 further includes a dynamic power controller or control unit 136, which may be directed to the control of the operations described herein and/or directed toward an intermediary control for the regulation and control of the powertrain 102 in vehicle system 100. In the illustrated embodiment, the dynamic power control unit 136 is provided with a cruise control (CC) controller 138 and a minimum speed control (MSC) controller 140. In other forms one or both of the CC controller 138 and/or the MSC controller 140 may be provided as a part of a different control unit, e.g., ECU 132 or TCU 134. In the illustrated embodiment, the CC controller 138 and the MSC controller 140 are provided in a common dynamic power control unit 136. In other forms, the CC controller 138 and the MSC controller 140 may be provided in separate control units in operative communication with one another.

The dynamic power control unit 136 is in operative communication with the ECU 130 and TCU 140. In certain embodiments, a portion or all of the of the dynamic power control unit 136 may be integrated within the ECU 130 or the TCU 140. In still other embodiments, at least one of the CC controller 138 and MSC controller 140 communicates with ECU 130 and/or dynamic power control unit 136 over a datalink 144 provided by a wired or wireless connection so that outputs of CC controller 138 and/or MSC controller 140 that are determined independently of dynamic power control unit 136 and/or ECU 132 can be provided to dynamic power control unit 136 and/or ECU 132. Communication between the hardware components of the electronic control system 130, may be conveyed via controlled area network (i.e., CAN bus) or any suitable communication protocol.

Electronic control system 130 and/or dynamic power control unit 136 may further be in operative communication with one or more of the plurality of vehicle sensors in vehicle system 100 and/or for receiving and transmitting conditions of vehicle system 100, such as temperature and pressure conditions, route conditions, terrain conditions, speed conditions, and weather conditions, for example. In certain embodiments, the electronic control system 130 and/or dynamic power control unit 136 may accept input from a global positioning system (GPS) receiver 146, which can provide the dynamic power control unit 136 with the route condition information, for example, the current latitude and longitude of the vehicle 101 relative to available data of the terrain of the route. Such terrain data may be stored within a navigation system of the vehicle 101, may be accessed in real-time via mobile communication link, or mode available by any suitable means.

In certain embodiments, the GPS receiver 146 may be a part of, or separate from, the navigation system of the vehicle 101. Alternatively, the GPS receiver 146 may be a part of the electronic control system 130 or may be disposed in a separate control module associated with the vehicle 101. The control scheme will be described in more detail below, but in general includes the ability to look ahead and use future road conditions/grades to influence control system actions. Unless otherwise indicated explicitly to the contrary, as used herein, the various embodiments described below in the other figures in which the description refers to future road grades can likewise utilize the full spectrum of look ahead road information not just limited to road grade, such as but not limited to speed limits, road hazards, etc. In this embodiment, the look ahead information is used to override torque limiting parameters and revert operation back to default torque limits to maintain a minimum vehicle speed over a route.

In certain embodiments, the look ahead data may be provided to the electronic control system 130 by an intelligent transportation system (ITS) or similar system. An ITS generally refers to the integration of information and communication technologies with transport infrastructure to improve economic performance, safety, mobility and environmental sustainability. An ITS may include real-time traffic information systems that collect data on traffic conditions, aggregate and translate the data, and disseminate the traffic data through various technologies. Such systems may enable dynamic route grade profiling through vehicle-to-vehicle communications, where grade information from preceding vehicles is provided to the dynamic power control unit 136. Similarly, vehicles in the proximity of the route may provide speed and gear state information indicative of traffic volume, actual traffic speeds, and other dynamic route condition information that the electronic control system 130 may use to control powertrain 102 to adjust the gear state and/or speed of vehicle 101.

For example, the controls may determine that it is not desired to increase vehicle speed or maintain a minimum vehicle speed where forward traffic or traffic control devices within the look-ahead window indicate that such changes would necessitate a braking event within a predetermined window. In a further example, where a speed increase or decrease is imminent based on information from the ITS, whether due to traffic, route grade, etc., the controls may control outputs from the powertrain 102 accordingly. Thus, the look ahead information may include data from other vehicles (e.g., via an ITS).

ECU 132, TCU 134, CC controller 138, and MSC controller 140 are exemplary components of an integrated circuit-based electronic control system 130 which may be configured to control various operational aspects of vehicle system 100 and powertrain 102 as described in further detail herein. An electronic control system 130 according to the present disclosure may be implemented in a number of forms and may include a number of different elements and configurations of elements. In certain preferred forms an electronic control system 130 may incorporate one or more microprocessor-based or microcontroller-based electronic control units sometimes referred to as electronic control modules.

An electronic control system 130 according to the present disclosure may be provided in forms having a single processing or computing component, or in forms comprising a plurality of operatively coupled processing or computing components; and may comprise digital circuitry, analog circuitry, or a hybrid combination of both of these types. The integrated circuitry of an electronic control system 130 and/or any of its constituent processors/controllers or other components may include one or more signal conditioners, modulators, demodulators, arithmetic logic units (ALUs), central processing units (CPUs), limiters, oscillators, control clocks, amplifiers, signal conditioners, filters, format converters, communication ports, clamps, delay devices, memory devices, analog to digital (A/D) converters, digital to analog (D/A) converters, and/or different circuitry or functional components as would occur to those skilled in the art to provide and perform the communication and control aspects disclosed herein.

The electronic control system 130 and/or any of the components 132, 134, 136, 138, 140 thereof includes stored data values, constants, and functions, as well as operating instructions stored on, for example, a computer readable medium. Any of the operations of exemplary procedures described herein may be performed at least partially by the electronic control system 130. In certain embodiments, the electronic control system 130 includes one or more controllers structured to functionally execute the operations of the controller. Further details of certain exemplary embodiments of controller operations are discussed below. Operations illustrated are understood to be exemplary only, and operations may be combined or divided, and added or removed, as well as re-ordered in whole or part, unless stated explicitly to the contrary herein.

Certain operations described herein include operations to interpret or determine one or more parameters. Interpreting or determining, as utilized herein, includes receiving values by any method, including at least receiving values from a datalink or network communication, receiving an electronic signal (e.g., a voltage, frequency, current, or pulse-width modulation (PWM) signal) indicative of the value, receiving a software parameter indicative of the value, reading the value from a memory location on a computer readable medium, receiving the value as a run-time parameter by any means known in the art, and/or by receiving a value by which the interpreted or determined parameter can be calculated, and/or by referencing a default value that is interpreted or determined to be the parameter value.

In one exemplary embodiment of dynamic power control unit 136, the CC controller 138 is configured to dynamically adjust the vehicle speed profile while the vehicle 101 is in a cruise control mode of operation using, for example, predictive cruise control. The electronic control system 130 further includes a cruise control governor 148, such as in ECU 132, that interfaces with CC controller 138 and selects a default torque limit for operation of prime mover 104 based a selected performance characteristic (e.g. fuel economy mode, maximum power mode, balanced mode, etc.) of the prime mover 104 and the cruise control reference speed determined by the CC controller 138. For example, CC controller 138 can use upcoming terrain data to optimize the vehicle speed profile to improve fuel economy by dynamically controlling the power output from prime mover 104 subject to the default torque limit of the selected performance characteristic. Any cruise control operating methodology in which the prime mover output power is dynamically managed to achieve one or more desired operating outcomes is contemplated herein.

In one exemplary embodiment of dynamic power control unit 136, the MSC controller 140 is configured to determine a torque limit override condition in response to look ahead route information for at least part of a route to be traveled by the vehicle 101. The torque limit override condition can be, for example, a predicted speed of the vehicle 101 along the route segment falling below a modified cruise control speed setting (e.g. a minimum vehicle speed) that is less than a current cruise control set speed. An external controller, such as dynamic power control unit 136, defines a modified torque limit for the prime mover 104 in response to the torque limit override condition that is different from the default torque limit under which the vehicle 101 is operating at the current cruise control set speed and selected performance characteristic. The MSC controller 140 controls the prime mover 104 in response to the torque limit override condition to propel the vehicle 101 along the route segment at a vehicle speed that is based on the modified cruise control speed setting, preventing the vehicle 101 from operating below, or maintaining a certain bandwidth from, a minimum vehicle speed.

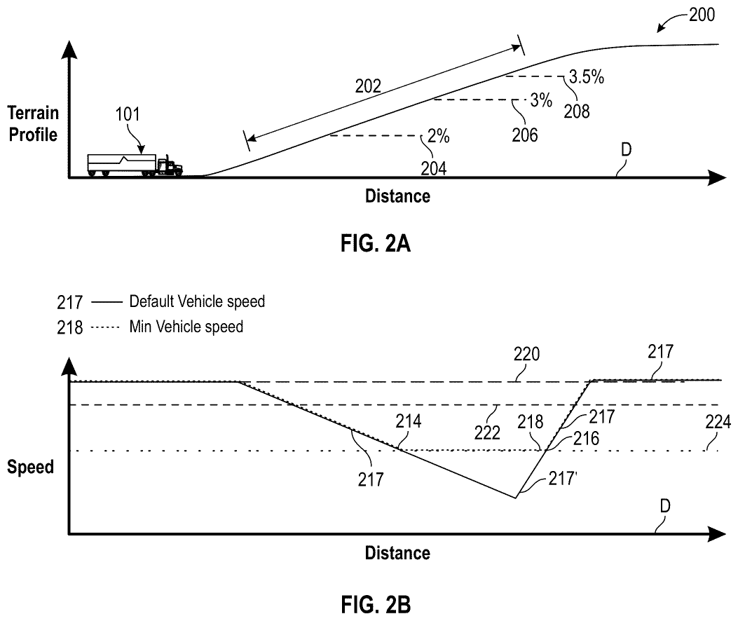

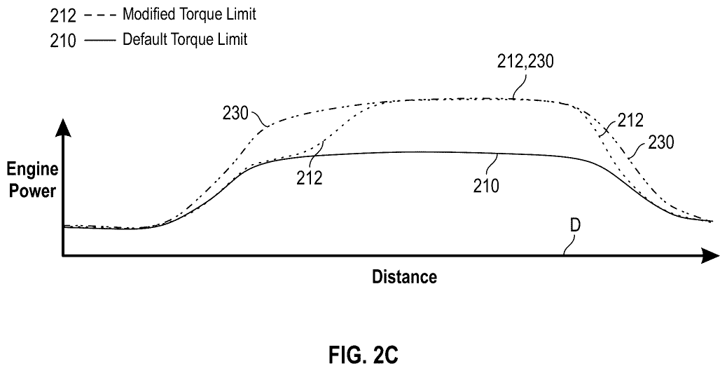

FIGS. 2A-2C show an exemplary implementation of electronic control system 130 to control a minimum speed of vehicle 101. In FIG. 2A, vehicle 101 is shown along a route 200 approaching a route segment 202 that includes a positive grade or incline. The route segment 202 may include one or more varying grade profiles 204, 206, 208 at different locations along distance D of route 200. It is contemplated that the grade profile(s) 204, 206, 208 for the current and look ahead route segment(s) 202 may be determined using a number of techniques including, for example, a computer model structured to determine or estimate grade information along route 200 from GPS 146, a map or geographic information system (GIS) data set which may be provided on board vehicle 101, or received via transmission from an ITS or other remote location, or combinations of such techniques.

In FIG. 2B there is shown cruise control set speed 220, a droop 222 from cruise control set speed 220, and an offset speed 224 that is less than cruise control set speed 220 and the droop 222 from the cruise control set speed 220. In an embodiment, the offset speed 224 is a modified cruise control speed setting that establishes a minimum vehicle speed for vehicle 101 along the route segment 202. In an embodiment, offset speed 224 is a user defined offset speed.

During operation of vehicle system 100, the prime mover 104 operates to maintain the vehicle 101 at the cruise control set speed 220 subject to a default torque limit 210 for prime mover 104. In an embodiment, the default torque limit 210 is associated with a user selected performance characteristic for prime mover 104. For example, the prime mover performance characteristic can be selected by the user from a number of performance levels ranging from maximum fuel economy, balanced between fuel economy and performance, and maximum power/performance. Performance levels between these performance levels are also contemplated. Each of the performance levels for the prime mover 104 can have a different default torque limit 210 for the associated performance characteristic against which the output of the prime mover 104 is controlled.

With continued reference to FIG. 2B, operation of vehicle 101 along the route segment 202 using the default torque limit 210 for control of the output from prime mover 104 will cause the default vehicle speed 217 to drop below the offset speed 224 at location 214 along the route segment 202. The location 214 at which the predicted vehicle speed 217′ will fall below offset speed 224 can be predicted using the dynamic power control unit 136 and look ahead information, or measured using onboard vehicle sensors. At or before location 214, the MSC controller 140 selects or establishes a modified torque limit 212 (FIG. 2C) for the prime mover 104 that is different from the default torque limit 210. The modified torque limit 212 allows the vehicle 101 to maintain a minimum vehicle speed 218 along route segment 202 that doesn't fall below, or is maintained within a threshold of, offset speed 224.

At location 216 along route segment 202, the prime mover 104 is determined to be able to maintain the vehicle speed above the offset speed 224 while operating under default torque limit 210. Therefore, at location 216, control of prime mover 104 reverts and/or is gradually transitioned to operation under default torque limit 210 for the user-selected performance characteristic for prime mover 104.

The electronic control system 130 is therefore configured to employ look-ahead data to minimize speed deviation of vehicle 101 along route segment 202 by easing, over-riding, or modifying the default torque limit 210 for the prime mover 104. Look ahead data and a minimum vehicle speed established by offset speed 224 from the cruise control set speed 220 dictate the torque output from prime mover 204 along route segment 202 subject to the modified torque limit 212 for prime mover 204. As a result, the torque output from prime mover 204 along route segment 202 can exceed default torque limit 210. In an embodiment, the modified torque limit 212 is set at a value that is in excess of default torque limit 210 and that also depends on the selected performance characteristic (e.g. fuel economy mode, maximum power mode, balanced mode, etc.) for prime mover 204.

The modified torque limit 212 maintains the minimum vehicle speed along portions of the route 200 in which the predicted vehicle speed will fall below offset speed 224 if the default torque limit 210 controls prime mover 204. When speed recovery above offset speed 224 is determined to be imminent, control of prime mover 204 is reverted back to the default torque limit 210. The implementation of minimum speed control along uphill route segments 202 prevents large, undesired drops in vehicle speed and improves minimum speed, reduces trip time, and improves fuel economy.

FIG. 2C shows engine power along distance D using the default torque limit 210 as compared to the modified torque limit 212. As can be observed, the modified torque limit 212 allows engine power in excess of the engine power available under the default torque limit 210 in order to maintain the minimum vehicle speed. In an embodiment, the modified torque limit 212 can ramped up along distance D from default torque limit 210 to the base torque rating 230 for the engine power to maintain the minimum vehicle speed.

When the location is determined at which engine power is sufficient to maintain the vehicle speed under default torque limit 210, the modified torque limit 212 can be ramped down from base rating 230 or other torque limit to the default torque limit 210 along distance D.

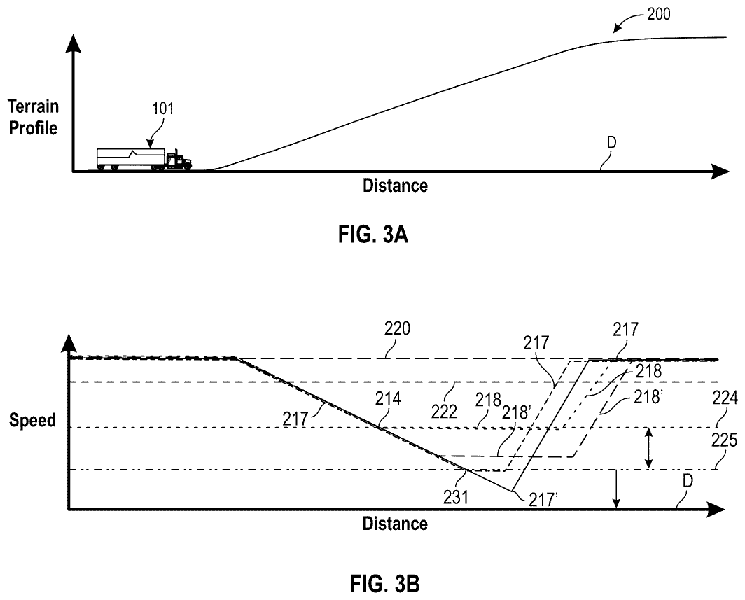

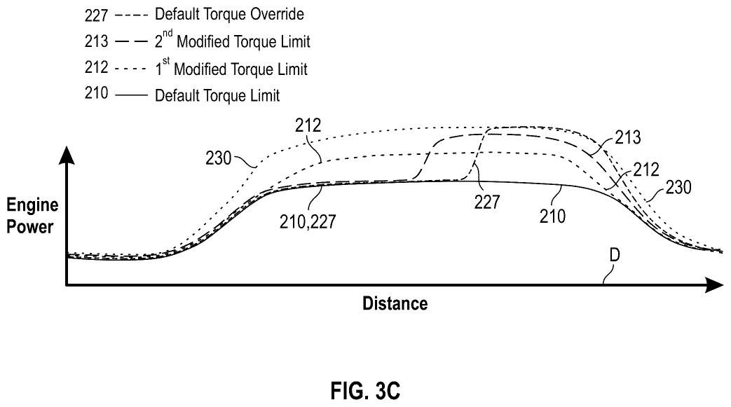

FIGS. 3A-3C show another exemplary implementation of electronic control system 130 to control a minimum speed of vehicle 101. The implementation in FIGS. 3A-3C is similar to the implementation in FIGS. 2A-2C, but includes an abort threshold 225 in which the minimum vehicle speed control according to the present disclosure is aborted if the look ahead vehicle speed 217′ is predicted to fall below abort threshold 225. As a result, operation of vehicle 101 is controlled non-predictively along distance D using a default torque override 227 that is ramped up at the location 231 along distance D where the vehicle speed 217 reaches abort threshold 225 so that the vehicle speed 217 does not fall below abort threshold 225

FIGS. 3B-3C also show a second modified torque limit 213 for minimum vehicle speed control of vehicle 101 during conditions in which the predicted default vehicle speed 217′ will fall between offset speed 224 and abort threshold 225. The second modified torque limit 213 will predictively control the minimum vehicle speed 218′ along portions of the route 200 in which the default vehicle speed 217′ is predicted to fall between offset speed 224 and abort speed 225.

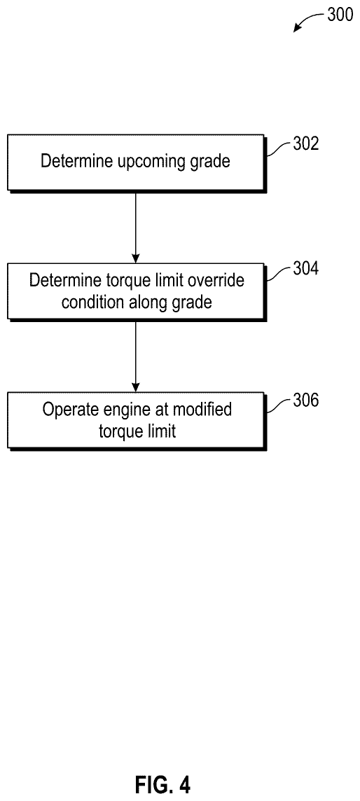

With reference to FIG. 4, there is illustrated a flow diagram of an example procedure 300 for controlling vehicle speed to maintain a minimum vehicle speed 218 along an uphill grade of the route segment 202 of route 200. Procedure 300 includes an operation 302 to determine an upcoming grade along a segment 202 of a route 200 the vehicle 101 is travelling.

Procedure 300 includes an operation 304 to determine a torque limit override condition for the prime mover 104 of the vehicle 101 along the route segment 202 based on the route conditions at segment 202 indicating a minimum vehicle speed cannot be maintained using the default torque limit 210 for prime mover 104. Procedure 300 includes an operation 306 to operate the prime mover 104 subject to a modified torque limit 212, 213 along the segment 202. The modified torque limit 212, 213 allows the minimum vehicle speed to be maintained above or within a threshold of offset speed 224 from the cruise control set speed 200 along the route segment 202.

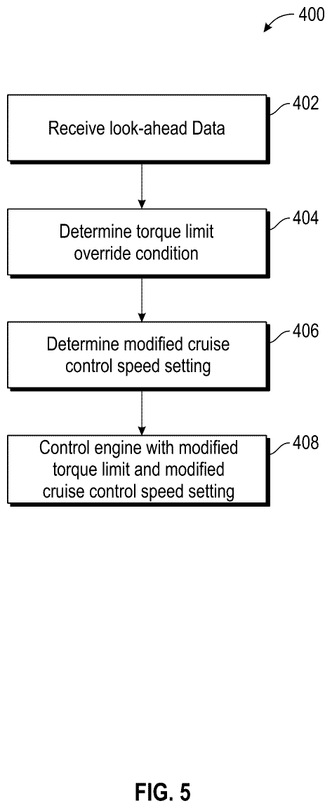

With reference to FIG. 5, a flow diagram of another embodiment procedure 400 is shown. Procedure 400 includes an operation 402 to receive look-ahead data for the route 200 along which vehicle system 100 is operating. In an embodiment, operation 402 includes looking at a predicted speed array for vehicle 101 that is based on the look ahead data for route 200.

Procedure 400 continues at operation 404 to determine a torque limit override condition along a segment 202 of route 200 in response to the look ahead data and/or predicted speed array. For example, the torque limit override condition can be an uphill grade along which prime mover 104 is unable to maintain a minimum vehicle speed due to default torque limit 210.

Procedure 400 continues at operation 406 to determine or establish a modified cruise control speed setting for the vehicle 101 to maintain a minimum vehicle speed 218, 218′ along segment 202. The modified cruise control speed setting can be, for example, an offset speed 224 from the cruise control set speed 220. The offset speed 224 can be user-defined or otherwise determined or selected to provide the desired drivability and performance improvement for vehicle 101 along segment 202.

Procedure 400 continues at operation 408 to predictively control prime mover 104 at a modified torque limit 212, 213 that allows the modified cruise control speed setting and/or minimum vehicle speed 218, 218′ to be maintained along the route segment 202. The modified torque limit 212, 213 pre-emptively over-rides or eases the default torque limit 210 at a pre-determined location along segment 202 that allows the minimum vehicle speed 218, 218′ to be maintained along the segment 202 until it is determined the prime mover 104 is able to operate vehicle 101 above the minimum vehicle speed while subject to default torque limit 210.

In an embodiment, procedures 300, 400 include determining the modified cruise control speed setting based on the default torque limit 210 and/or an offset speed 224 from a cruise control speed setting 220. In an embodiment, the modified cruise control speed setting is based on fuel economy, power, balance or other prime mover performance characteristic associated with the default torque limit 210.

In an embodiment of procedures 300, 400, the default torque limit 210 is a user-selected torque limit for the prime mover 204 based on a desired performance characteristic. In an embodiment of procedures 300, 400, the modified torque limit 212, 213 is greater than the default torque limit 210. In an embodiment of procedures 300, 400, the torque limit override condition includes a positive grade section or segment 202 of the route 200 along which the speed of the vehicle system 101 under the default torque limit 210 is predicted to be less than the modified cruise control speed setting based on the look ahead route information.

In an embodiment, procedures 300, 400 include reverting control of the prime mover 204 to the default torque limit 210 in response to determining a predicted speed for the vehicle system 101 will exceed the modified cruise control speed setting under the default torque limit 210. In an embodiment, the default torque limit 210 is reverted to at a location along the route 200 in which the look ahead information indicates the predicted speed will exceed the modified cruise control speed setting under the default torque limit 210.

In an embodiment, procedures 300, 400 include determining the user defined offset speed cannot be maintained under full engine power based on the look ahead data. In an embodiment, the default torque limit 210 is followed to the offset speed 224 and then all torque limiting 210 is eased in order to diminish speed loss below offset speed 224 to maintain a minimum vehicle speed 218, 218′. Control of prime mover 204 is reverted to the default torque limit 210 as discussed above.

A number of exemplary further exemplary embodiments shall now be further described with reference to the claims appended hereto. A vehicle system is provided that includes a prime mover configured to output torque that is controlled in response to a default torque limit, a transmission structured to receive the torque output from the prime mover and propel the vehicle system at a cruise control set speed associated with the default torque limit, and an electronic control system operatively coupled with the prime mover and the transmission. The electronic control system is configured to determine a torque limit override condition in response to look ahead route information for at least part of a route traveled by the vehicle system. The torque limit override condition overrides the default torque limit. The control system is further configured to control the prime mover in response to the torque limit override condition at a modified torque limit to propel the vehicle system at a speed that is based on a modified cruise control speed setting that is less than the cruise control set speed.

In an embodiment, the modified cruise control speed setting is based on the default torque limit. In a further embodiment, the modified cruise control speed setting is based on a prime mover performance characteristic associated with the default torque limit. In a further embodiment, the prime mover performance characteristic is selectable from a number of performance levels ranging from maximum fuel economy to maximum power, and each of the performance levels has a different default torque limit for the prime mover.

In an embodiment, the default torque limit is a user-selected torque limit for the prime mover. In an embodiment, the modified torque limit is greater than the default torque limit.

In an embodiment, the torque limit override condition includes a positive grade section of the route along which the vehicle speed is predicted to be less than the modified cruise control speed setting based on the look ahead route information.

In an embodiment, the electronic control system is configured to revert control of the prime mover to the default torque limit in response to determining a predicted speed for the vehicle system will exceed the modified cruise control speed setting under the default torque limit. In a further embodiment, the control of the prime mover is reverted to the default torque limit at a location along the route in which the look ahead information indicates the predicted speed will exceed the modified cruise control speed setting under the default torque limit.

In another aspect of the disclosure, a method is provided for controlling a vehicle system including a prime mover, a transmission coupled with the prime mover, and an electronic control system coupled with the prime mover and the transmission. The method includes operating the electronic control system to perform the operations of determining a torque limit override condition in response to look ahead route information for at least part of a route to be traveled by the vehicle system. The torque limit override condition overrides a default torque limit for the prime mover. The method further includes controlling the prime mover in response to the torque limit override condition at a modified torque limit to propel the vehicle system at a speed that is based on a modified cruise control speed setting that is less than the cruise control set speed.

In an embodiment, the electronic control system is further configured to perform the operation of determining the modified cruise control speed setting based on the default torque limit. In an embodiment, the modified cruise control speed setting varies based on a prime mover performance characteristic associated with the default torque limit.

In an embodiment, the default torque limit is a user-selected torque limit for the prime mover. In an embodiment, the modified torque limit is greater than the default torque limit.

In an embodiment, the torque limit override condition includes a positive grade section of the route along which the speed of the vehicle system under the default torque limit is predicted to be less than the modified cruise control speed setting based on the look ahead route information.

In an embodiment, the electronic control system is further configured to perform the operation of reverting control of the prime mover to the default torque limit in response to determining a predicted speed for the vehicle system will exceed the modified cruise control speed setting under the default torque limit. In a further embodiment, the electronic control system is configured to perform the operation of reverting to the default torque limit at a location along the route in which the look ahead information indicates the predicted speed will exceed the modified cruise control speed setting under the default torque limit.

In another aspect of the disclosure, an apparatus includes an electronic control system configured to control operation of a prime mover and a transmission of a vehicle system by executing instructions stored in a non-transitory controller-readable medium. The control system is configured to determine a torque limit override condition in response to look ahead route information for at least part of a route to be traveled by the vehicle system. The torque limit override condition includes overriding a default torque limit for the prime mover. The control system is further configured to control the prime mover in response to the torque limit override condition at a modified torque limit to propel the vehicle system at a speed that is based on a modified cruise control speed setting that is less than the cruise control set speed.

According to another aspect of the present disclosure, a method for operating a vehicle along a route includes determining an upcoming grade along the route in response to look ahead route information; determining a torque limit override condition for operation of a prime mover of the vehicle along the upcoming grade by overriding a default torque limit of the prime mover; and operating the prime mover at a modified torque limit that is greater than the default torque limit in response to a speed of the vehicle decreasing a threshold amount from the cruise control set speed.

In an embodiment of the method, the threshold amount corresponds to an offset between the cruise control set speed and a modified cruise control set speed. The method further includes determining the default torque limit is capable of operating the vehicle along the grade at or above the cruise control set speed and returning operation the prime mover to the default torque limit in response to the determination.

As will be understood by one skilled in the art having the benefit of the present disclosure, the terms used to identify the components of the systems and methods disclosed herein may be similarly described by other terms unless explicitly provided to the contrary. While various embodiments of an engine and transmission control system and methods for using the same have been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected. A variety of further embodiments according to the present disclosure are contemplated. Those skilled in the art will appreciate that many modifications are possible in the example embodiments without materially departing from this disclosure. Accordingly, all such modifications are intended to be included within the scope of this disclosure as defined in the following claims.

What is claimed is:

1. A vehicle system, comprising:
a prime mover configured to output torque that is controlled in response to a default torque limit;
a transmission structured to receive the torque output from the prime mover and propel the vehicle system at a cruise control set speed associated with the default torque limit;
an electronic control system operatively coupled with the prime mover and the transmission, the electronic control system being configured to:
determine a torque limit override condition in response to look ahead route information for at least part of a route traveled by the vehicle system, the torque limit override condition overriding the default torque limit; and
control the prime mover in response to the torque limit override condition at a modified torque limit to propel the vehicle system at a speed that is based on a modified cruise control speed setting that is less than the cruise control set speed.

2. The vehicle system of claim 1, wherein the modified cruise control speed setting is based on the default torque limit.

3. The vehicle system of claim 2, wherein the modified cruise control speed setting is based on a prime mover performance characteristic associated with the default torque limit.

4. The vehicle system of claim 3, wherein the prime mover performance characteristic is selectable from a number of performance levels ranging from maximum fuel economy to maximum power, and each of the performance levels has a different default torque limit for the prime mover.

5. The vehicle system of claim 1, wherein the default torque limit is a user-selected torque limit for the prime mover.

6. The vehicle system of claim 1, wherein the modified torque limit is greater than the default torque limit.

7. The vehicle system of claim 1, wherein the torque limit override condition includes a positive grade section of the route along which the vehicle speed is predicted to be less than the modified cruise control speed setting based on the look ahead route information.

8. A vehicle system according to claim 1, wherein the electronic control system is configured to revert control of the prime mover to the default torque limit in response to determining a predicted speed for the vehicle system will exceed the modified cruise control speed setting under the default torque limit.

9. A vehicle system according to claim 8, wherein the control of the prime mover is reverted to the default torque limit at a location along the route in which the look ahead information indicates the predicted speed will exceed the modified cruise control speed setting under the default torque limit.

10. A method of controlling a vehicle system including a prime mover, a transmission coupled with the prime mover, and an electronic control system coupled with the prime mover and the transmission, the method comprising operating the electronic control system to perform the operations of:
determining a torque limit override condition in response to look ahead route information for at least part of a route to be traveled by the vehicle system, the torque limit override condition overriding a default torque limit for the prime mover; and
controlling the prime mover in response to the torque limit override condition at a modified torque limit to propel the vehicle system at a speed that is based on a modified cruise control speed setting that is less than the cruise control set speed.

11. The method according to claim 10, wherein the electronic control system is further configured to perform the operation of determining the modified cruise control speed setting based on the default torque limit.

12. The method according to claim 10, wherein the modified cruise control speed setting varies based on a prime mover performance characteristic associated with the default torque limit.

13. The method according to claim 10, wherein the default torque limit is a user-selected torque limit for the prime mover.

14. The method according to claim 10, wherein the modified torque limit is greater than the default torque limit.

15. The method according to claim 10, wherein the torque limit override condition includes a positive grade section of the route along which the speed of the vehicle system under the default torque limit is predicted to be less than the modified cruise control speed setting based on the look ahead route information.

16. The method according to claim 10, wherein the electronic control system is further configured to perform the operation of reverting control of the prime mover to the default torque limit in response to determining a predicted speed for the vehicle system will exceed the modified cruise control speed setting under the default torque limit.

17. The method according to claim 16, wherein the electronic control system is further configured to perform the operation of reverting to the default torque limit at a location along the route in which the look ahead information indicates the predicted speed will exceed the modified cruise control speed setting under the default torque limit.

18. An apparatus, comprising:
an electronic control system configured to control operation of a prime mover and a transmission of a vehicle system by executing instructions stored in a non-transitory controller-readable medium to perform the operations of:
determine a torque limit override condition in response to look ahead route information for at least part of a route to be traveled by the vehicle system, the torque limit override condition overriding a default torque limit for the prime mover; and
control the prime mover in response to the torque limit override condition at a modified torque limit to propel the vehicle system at a speed that is based on a modified cruise control speed setting that is less than the cruise control set speed.

19. A method for operating a vehicle along a route, comprising:
determining an upcoming grade along the route in response to look ahead route information;
determining a torque limit override condition for operation of a prime mover of the vehicle along the upcoming grade by overriding a default torque limit of the prime mover; and
operating the prime mover at a modified torque limit that is greater than the default torque limit in response to a speed of the vehicle decreasing a threshold amount from the cruise control set speed.

20. The method of claim 19, wherein the threshold amount corresponds to an offset between the cruise control set speed and a modified cruise control set speed, and further comprising determining the default torque limit is capable of operating the vehicle along the grade at or above the cruise control set speed and returning operation the prime mover to the default torque limit in response to the determination.
